(19) United States
(12) Patent Application Publication
(10) Pub. No.: US 2004/0003966 A1
(43) Pub. Date: Jan. 8, 2004

(54) Scaffolding system

(76) Inventor: Wayne J Yeoman, Pleasant View, UT (US)

Correspondence Address: John E. Schone, 1759 No. 250 W., Layton, UT, 84041, US

(21) Appl. No.: 10/190,050

(22) Filed: Jul. 8, 2002

(51) Int. Cl. E06C 7/16

(52) U.S. Cl. 182/118

(57) ABSTRACT

A scaffolding system utilizing upright ladders and commonly available sawhorses. The ladders have frames attached which are adapted for enclosing the horizontal beam of a sawhorse and other similar ground support systems. The frames enclose the sawhorse horizontal beam tautly and maintain the ladder securely and in an upright fashion. Ordinary planking is then set on the rungs of opposing ladders to provide a working platform.

### BACKGROUND OF THE INVENTION

This invention pertains to scaffolding systems and more particularly to scaffolding systems that are supported from the ground as opposed to scaffolding systems that are supported by overhead ropes or cables. The need for scaffolding systems to allow workmen to work at elevated heights on buildings and other fabricated structures has been known and recognized for thousands of years. Scaffolding systems have been developed in response to this need and most of them function very well for the purposes for which they are intended.

Some of the most elementary scaffolding systems are based upon the use of ladders and, in particular, the use of stepladders. Working platforms such as planks are commonly set on the rungs of opposing stepladders to create elementary scaffolding systems upon which workmen may operate. Systems of this type have the advantage of being easily set up and are able to take advantage of commonly available equipment such as stepladders and metal and wood planking which can be used as the work platform. No specialized scaffolding system or equipment has to be purchased. Since the work platform planking can easily be moved to different levels on the stepladders, these simplified systems have some capability of providing work platforms of different heights.

Scaffolding systems of this simplistic type, however, have several disadvantages. The height at which the workmen can operate is limited to the height of the stepladders, which is typically eight feet or less. Furthermore, the stability of such systems is not very good since stepladders have to be set up under different ground conditions and on uneven or irregular ground. The work platforms are not always level therefore.

Many different types of specialized scaffolding systems have been developed to address the problems that these simplified and simplistic systems present. Modular systems built with tubular members are commonly found and have the capability of being extendible to significant heights. Many of these systems also have the ability to compensate for irregular ground conditions by providing individual extendible legs or other specialized ground support systems. Systems of this type, however, are often expensive and time-consuming to erect and move. In addition, they provide more capability than is needed by many workmen who need less expensive and smaller scaffolding systems.

The present invention meets the needs of many classes of workmen who need a scaffolding system in which they can use commonly available ground support systems such as sawhorses and work benches, and, at the same time, utilize ladders to create scaffolding height without having to resort to specialized scaffolding systems. It is therefore an object of this invention to utilize commonly available sawhorses and ground support systems as a base for scaffolding systems which make use of upright, non-self supporting ladders. This allows for working platforms, which are usually wooden or metal planks, to be supported between the rungs of opposing ladders and for the ladders to rest on the sawhorses or other ground support systems.

It is another object of the invention to provide a means of attaching the upright ladders to the ground support systems and sawhorses in such a way that the ladders are secure and are at the same time easily detachable from the ground support systems. Finally, it is an object of the invention to provide for a stable and level scaffolding system by means of extendible legs on the sawhorses or ground support systems in order to make a level support for the upright ladders.

### SUMMARY OF THE INVENTION

In accordance with these and other objects, the present invention is directed to the features of a scaffolding system fabricated from upright ladders and ground support systems such as commonly available sawhorses. The scaffolding system would be of the type in which a work platform rests on the ladder rungs of opposing ladders. A complete scaffolding system would comprise at least two ladders each having an upper end and a base end, a ground-engaging support system for each of the ladders with each of the ground-engaging support systems having a horizontal beam attached to a plurality of downward sloping legs. A commonly available ground-engaging support system would be a sawhorse. In addition, specially fabricated folding benches in which the downward sloping legs are collapsible, extendible and foldible, such as the type sold under the trademark as a WAL-BOARD aluminum folding bench, are also particularly useful as the ground-engaging support system for the ladders.

In addition to the ladders and the ground-engaging support systems, a complete scaffolding system would also include ladder-mounted means for detachably securing each of the ladders to the horizontal beam of the ground-engaging support system. One of the said means for securing the ladder to the ground-engaging support system, in accordance with the invention, would be fabricated with two bottomly open frames for each of the ladders. A scaffolding system with two ladders would therefore require a total of four such bottomly open frames. Each of these frames has a horizontal upper member and two downwardly depending members. The downwardly depending members are located at opposite ends of the horizontal upper member and each downwardly depending member has a hole therein. Furthermore, each of the bottomly open frames is attached at the horizontal upper member to a side rail of the ladder at the base end of the ladder. In order to secure the ladder to the ground-engaging support system and in order to make the ladder upright and steady, a plurality of braces connects the side rails of the ladder to the horizontal upper member of the bottomly open frames such that each bottomly open frame is strengthened and prevented from twisting.

The bottomly open frame encloses the horizontal beam of the ground-engaging support system and is located such that the holes in the downwardly depending members of the bottomly open frame are located below the lower surface of the horizontal beam of the ground-engaging support system. This allows for a rod to be placed through the holes of both of the downwardly depending members of the bottomly open frames to secure the bottomly open frame to the horizontal upper member of the ground engaging support system and easily allows for the ladder to be removed from the ground-engaging support system by merely removing the rod.

An alternative method of securing the ladder to the ground-engaging support system involves the use of a frame having an upper plate and two downwardly depending end plates attached at opposite ends of the upper plate with the frame also having a detachable bottom plate attached to each of the downwardly depending plates. Each of the frames is attached at the upper plate to a side rail of the ladder at the base end of the ladder. The side rails of the ladder are attached to the upper plate of each of the frames by a plurality of braces which strengthen the frames and prevent them from twisting.

Each of the frames encloses the horizontal beam of the ground-engaging support system such that the frame may be detachably secured in place by means of the bottom plate. Through the use of ground-engaging support systems such as the aluminum folding bench sold under the tradename WAL-BOARD with its collapsible and folding legs it is possible to adjust and level the ground-engaging support system by extending the legs of the folding bench until a level condition is achieved. This stabilizes the ladder and the entire scaffolding system and provides for a more useful and usable work platform for the workmen who are utilizing the scaffolding system.

These and other features, advantages and objects of the invention will become more readily understood from the following description taken in conjunction with the attached drawings wherein the numerals stated herein refer to corresponding parts identified in the drawings.

### BRIEF DESCRIPTION OF THE DRAWINGS

For a better understanding of the invention, reference may be made to the following description of exemplary embodiments thereof taken in conjunction with the accompanying drawings, in which:

FIG. 1 is a perspective view of a scaffolding system showing two opposing ladders each attached to a ground-engaging support system. The drawing also shows a plank or working platform supported by ladder rungs of opposing ladders;

FIG. 2 is a perspective view of a portion of the scaffolding system showing a ladder with a frame for engaging the horizontal upper beam of the ground-engaging support system;

FIG. 3 is another perspective view of a portion of the scaffolding system showing a ladder with an alternative embodiment of a frame for engaging and enclosing the ground-engaging support system.

### DETAILED DESCRIPTION OF THE INVENTION

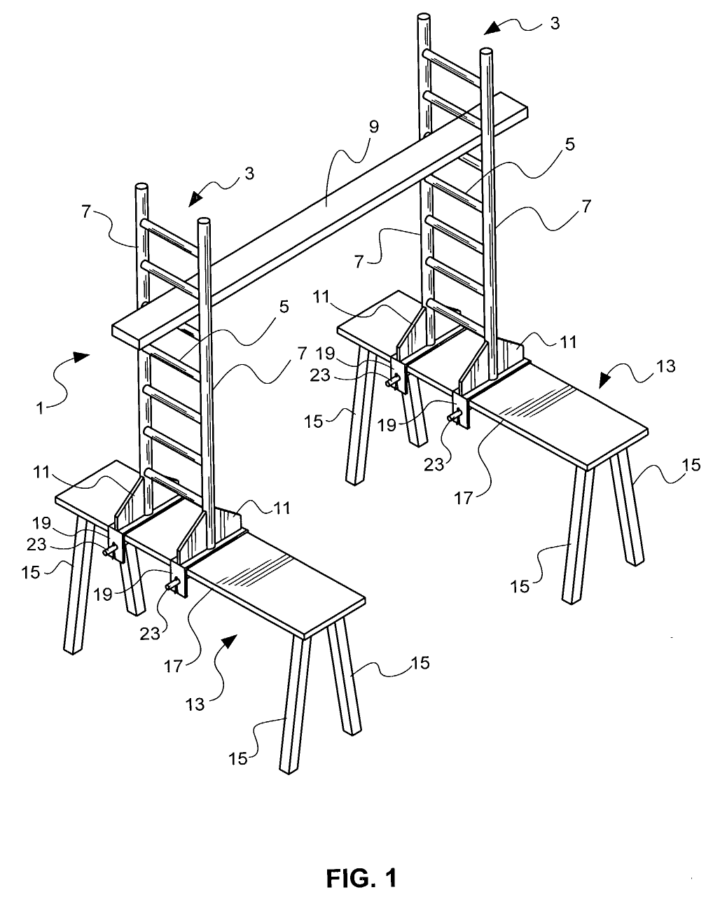

As is evident from FIG. 1 the scaffolding system 1 in accordance with the present invention utilizes a ladder 3 specially adapted to attach to a ground-engaging support system 13. In order to create a complete scaffolding system two such ladders 3, each mounted on ground-engaging support system 13, would be required in order that work platform 9 could be supported in ladder rungs 5.

Scaffolding system 1 will now be described in more detail. Ladder 3 is a typical, commonly available ladder used for functions such as house painting, roofing and other tasks performed at elevated heights. Normally, such a ladder must be supported by the building against which it rests since the ladder has no legs or other support devices to allow it to stand independently upright. Ladders of this type are commonly manufactured from lumber or metals such as aluminum or steel. In the preferred embodiment, the ladder would be manufactured from steel in order that the ladder side rails 7 can be welded to braces 11 which provide additional support to the ladders 3 when mounted on ground-engaging support system 13.

FIG. 1, which is a perspective view of scaffolding system 1, shows how braces 11 are attached to ladder side rails 7 in order to assure that ladder 3 is upright and held rigidly. Ladder 3 is mounted on ground-engaging support system 13 and supported by braces 11 so that work platform 9 can rest on ladder rungs 5 and provide a safe working environment for the workmen who need to utilize the scaffolding system 1. Work platform 9 can be either a wooden plank or a metal platform, but in either event, it is portable and removable and can be set at any height as needed by merely changing the ladder rungs 5 on which it is mounted. Ladders 3 can provide about any height desired by a workman by selecting a ladder of the appropriate length or by utilizing a ladder with readily available extension modules to provide additional height.

Ladder 3 is mounted on ground-engaging support system 13, which can be a simple wooden sawhorse, if desired. Ground-engaging support system 13 is composed of a horizontal beam 17 with an upper surface and a lower surface and four or more downwardly and outwardly depending legs 15, which support the horizontal beam 17 and the ladder 3. If an ordinary sawhorse is used in the capacity of the ground-engaging support system 13, then horizontal beam 17 and legs 15 will typically be manufactured from wood. Ground-engaging support system 13 can also be fabricated from metals such as aluminum and steel. In the preferred embodiment ground-engaging support system 13 would be a folding bench with collapsible and folding legs, manufactured from aluminum and of the type as manufactured and sold under the trademark WAL-BOARD. The WAL-BOARD (™) folding bench is particularly well balanced and designed for drywall and painting operations that have to be performed at relatively high elevations. Folding benches of the WAL-BOARD (™) type utilize several cross-braces to stabilize the bench and also incorporate legs which can be extended as necessary to achieve a level condition.

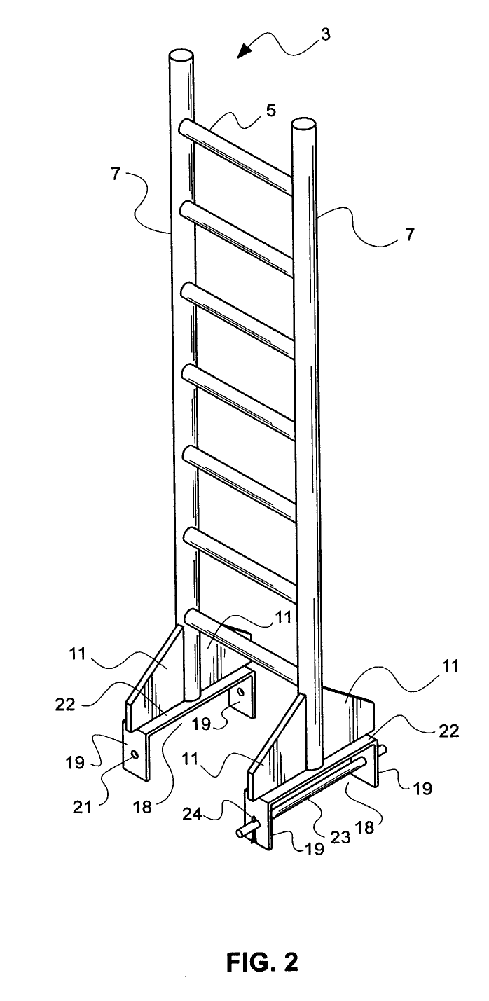

As best viewed in FIG. 2 in combination with FIG. 1, ladder 3 is secured to ground-engaging support system 13 by bottomly open frames 18 which enclose horizontal beam 17 of ground-engaging support system 13 and are securely attached to horizontal beam 17 as described in more detail below. Bottomly open frames 18 are attached to ladder side rails 7 and are further secured by braces 11. Bottomly open frames 18 can be fabricated from any strong and rigid material such as wood, plastic or metal. In the preferred embodiment, bottomly open frames 18 are manufactured from steel and are welded to braces 11 at the bottom end of ladder side rails 7. Similarly, braces 11 can also be manufactured from any sufficiently rigid material such as plastic, metal or wood to support ladder 3 in an upright, rigid and unmovable position, but as with bottomly open frames 18, braces 11 are also typically manufactured from steel in order that they can be welded to bottomly open frames 18 and to ladder side rails 7.

Bottomly open frames 18 are composed of a horizontal upper member 22 and downwardly depending members 19 located at opposite ends of horizontal upper member 22. Both downwardly depending members 19 and horizontal upper member 22 can be manufactured from any sufficiently rigid material such as plastic, wood or metal, but in the preferred embodiment they are manufactured from steel. Downwardly depending members 19 can be formed by bending horizontal upper member 22 at 90° angles or they can be attached to horizontal upper member 22 in some other appropriate fashion. In the preferred embodiment, downwardly depending members 19 would be welded to horizontal upper member 22 and braces 11 would also be welded to horizontal upper member 22.

Downwardly depending members 19 each have a hole 21 drilled therein to allow rod 23 to be inserted through said holes 21. Holes 21 are located just below the bottom of horizontal beam 17 such that when rod 23 is inserted through holes 21, horizontal beam 17 is completely enclosed and is thereby secured to ladder 3 Holes 21 can be drilled as close to the bottom surface of horizontal beam 17 as desired in order to provide as snug a fit as is necessary in order to keep ladder 3 from moving. Rod 23 can also be fabricated from any sufficiently rigid material such as wood, plastic or metal, but in the preferred embodiment it is manufactured from steel. Rod 23 can be secured from moving in and out of hole 21 through use of restraining devices such as nuts or bolts and in the preferred embodiment a cotter pin 24 would be utilized.

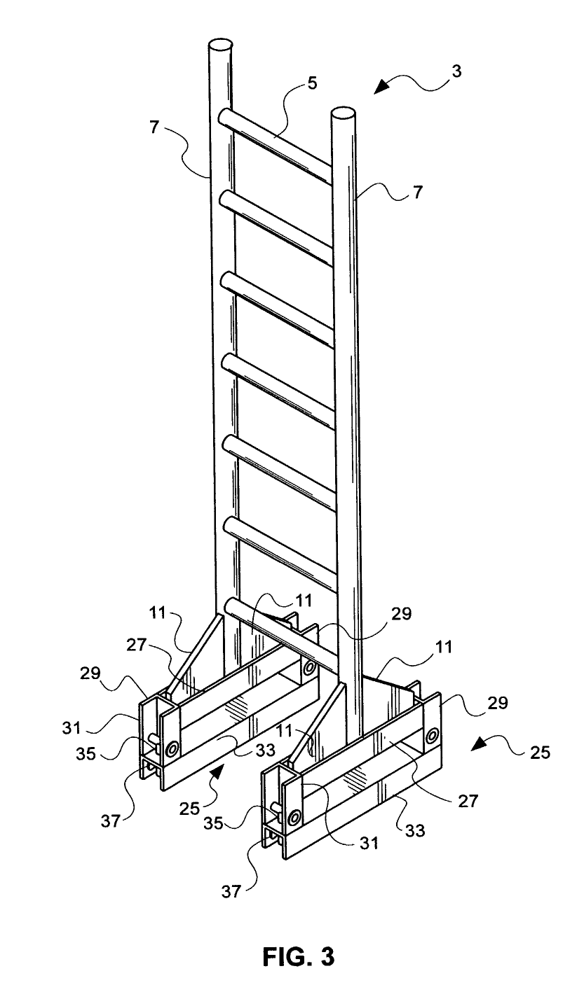

FIG. 3 depicts an alternative approach for mounting and securing ladder 3 to ground-engaging support system 13. As can be seen, frames 25 are attached at the base end of ladder side rails 7. Frames 25 are composed of upper plate 27, end plates 29 which are downwardly depending and attached at opposite ends of upper plate 27 and a detachable bottom plate 33. Upper plate 27, end plates 29 and bottom plate 33 can be fabricated from any sufficiently rigid material such as wood, plastic or metal but in the preferred embodiment, they are all fabricated from steel. Upper plate 27 is typically welded to braces 11, which are, in turn, welded to ladder side rails 7. This arrangement assures that frames 25 are rigid and securely attached to ladder 3. Frame 25 is thereby prevented from twisting. End plates 29 can be attached to upper plate 27 in any convenient fashion, but in the preferred embodiment they are welded.

Bottom plate 33 is attached to end plates 29 as further described below. Upper plate 27, end plates 29 and bottom plate 33 create a frame which securely encloses horizontal beam 17 of ground-engaging support system 13. Frame 25, when enclosing horizontal beam 17, can be designed to fit as snugly as is felt to be desirable.

Frame 25 completely encloses horizontal beam 17 through the use of upper plate 27, end plates 29 and bottom plate 33. Bottom plate 33 is attached to end plates 29 in a manner that allows for easy removal. The method of attachment is described below. End plates 29 are each composed of flanges 31 as can be readily seen in FIG. 3. Between the flanges of end plates 29 is attached a downwardly depending bolt 35 as can be seen in FIG. 3. Bolt 35, in turn, projects through holes found at opposite ends of bottom plate 33 which allow bottom plate 33 to be secured to end plates 29 by means of nut 37 that is secured and attached to bolt 35 at both ends of bottom plate 33. Accordingly, bottom plate 33 can be detached from frame 25 by merely undoing nuts 37 from bolts 35.

Although the invention has been described and illustrated herein with reference to specific embodiments thereof, it will be understood that such embodiments are susceptible of variation and modification without departing from the inventive concepts disclosed. All such variations and modifications, therefore, are intended to be included within the spirit and scope of the appended claims.

I claim:

1. In a scaffolding system of the type in which a work platform rests on the ladder rungs of opposing ladders, a scaffolding system comprising;
at least two ladders;
a ground engaging support system for each ladder, each such ground engaging support system having a horizontal beam attached to a plurality of downwardly sloping legs;
ladder mounted means for detachably securing each said ladder to the horizontal beam of said ground engaging support system.

2. The scaffolding system of claim 1, wherein the ground engaging support system is a sawhorse.

3. The scaffolding system of claim 1, wherein the ground engaging support system is a folding bench having downwardly sloping legs.

4. The scaffolding system of claim 3, wherein the downwardly sloping legs of the folding bench are extendible.

5. A scaffolding system comprising;
at least two ladders, each ladder having two side rails with each side rail having an upper end and a base end;
at least four bottomly open frames, each frame having a horizontal upper member and two downwardly depending members, the downwardly depending members located at opposite ends of the horizontal upper member and each downwardly depending member having a hole therein;
each of the bottomly open frames attached at the horizontal upper member to a side rail of the ladder at the base end of said ladder;
a plurality of braces connecting the side rails of the ladder to the horizontal upper member of the bottomly open frames whereby the bottomly open frames are strengthened and prevented from twisting;
a ground engaging support system having a horizontal beam attached to a plurality of downwardly sloping legs, the horizontal beam having an upper surface and a lower surface;
each bottomly open frame enclosing the horizontal beam of the ground engaging support system;
said downwardly depending members of the bottomly open frame located such that the holes in said members are below the lower surface of the horizontal beam of the ground engaging support system;
a rod through the holes of both of the downwardly depending members of each of the bottomly open frames whereby the bottomly open frame can be detachably secured to the horizontal beam of the ground engaging support system.

6. The scaffolding system of claim 5, wherein the ground engaging support system is a sawhorse.

7. The scaffolding system of claim 5, wherein the ground engaging support system is of the type having collapsible and extendible legs.

8. The scaffolding system of claim 5, wherein the braces are welded to the side rails of the ladder.

9. The scaffolding system of claim 5, wherein the braces are welded to the horizontal upper member of the bottomly open frames.

10. The scaffolding system of claim 5, wherein the rod is restrained from moving by a cotter pin.

11. A scaffolding system comprising;
at least two ladders, each ladder having two side rails with each side rail having an upper end and a base end;
at least four frames each frame having an upper plate, two downwardly depending end plates attached at opposite ends of said upper plate, and a detachable bottom plate attached to each of the downwardly depending plates;
each of the frames attached at the upper plate to a side rail of the ladder at the base end of said ladder;
a plurality of braces connecting the side rails of the ladder to the upper plate of each of the frames whereby the frames are strengthened and prevented from twisting;
a ground engaging support system having a horizontal beam attached to a plurality of downwardly sloping legs;
each frame enclosing the horizontal beam of the ground engaging support system whereby the said frame may be detachably secured in place by means of the bottom plate.

12. The scaffolding system of claim 11, wherein the ground engaging support system is a sawhorse.

13. The scaffolding system of claim 11, wherein the ground engaging support system is of the type having collapsible and extendible legs.

14. The scaffolding system of claim 11, wherein the braces are welded to the side rails of the ladder.

15. The scaffolding system of claim 11, wherein the braces are welded to the upper plate of the frames.

16. The scaffolding system of claim 11, wherein each of the downwardly depending end plates of the frame has attached flanges and the bottom plate has holes located at opposite ends of the bottom plate.

17. The scaffolding system of claim 16 wherein a downwardly depending bolt is secured between each of the flanges attached to the downwardly depending end plates and said bolt is attached with a nut to the bottom plate through the holes in the bottom plate.

18. In a scaffolding system of the type in which a work platform rests on the ladder rungs of opposing ladders, and each ladder resting on a ground support system of the type having a horizontal beam attached to a plurality of downwardly sloping legs, a scaffolding ladder comprising;
a ladder;
ladder mounted means for detachably securing each said ladder to the horizontal beam of said ground engaging support system.

19. In a scaffolding system of the type in which a work platform rests on the ladder rungs of opposing ladders, and each ladder resting on a ground support system of the type having a horizontal beam with upper and lower surfaces and said horizontal beam attached to a plurality of downwardly sloping legs, a scaffolding ladder comprising;
a ladder having two side rails with each side rail having an upper end and a base end;
two bottomly open frames, each frame having a horizontal upper member and two downwardly depending members, the downwardly depending members located at opposite ends of the horizontal upper member and each downwardly depending member having a hole therein;
each of the bottomly open frames attached at the horizontal upper member to a side rail of the ladder at the base end of said ladder;
a plurality of braces connecting the side rails of the ladder to the horizontal upper member of the bottomly open frames whereby the bottomly open frames are strengthened and prevented from twisting;
said downwardly depending members of the bottomly open frame located such that the holes in said members are located below the lower surface of the horizontal beam of the ground engaging support system;
a rod through the holes of both of the downwardly depending members of each of the bottomly open frames whereby the bottomly open frame can be detachably secured to the horizontal beam of the ground engaging support system.

20. The scaffolding ladder of claim 19, wherein the braces are welded to the side rails of the ladder.

21. The scaffolding ladder of claim 19, wherein the braces are welded to the horizontal upper member of the bottomly open frames.

22. The scaffolding ladder of claim 19, wherein the rod is restrained from moving by a cotter pin.

23. In a scaffolding system of the type in which a work platform rests on the ladder rungs of opposing ladders, and each ladder resting on a ground support system of the type having a horizontal beam attached to a plurality of downwardly sloping legs, a scaffolding ladder comprising;
a ladder having two side rails with each side rail having an upper end and a base end;
two frames, each frame having an upper plate, two downwardly depending end plates attached at opposite ends of said upper plate, and a detachable bottom plate attached to each of the downwardly depending plates;
each of the frames attached at the upper plate to a side rail of the ladder at the base end of said ladder;
a plurality of braces connecting the side rails of the ladder to the upper plate of each of the frames whereby the frames are strengthened and prevented from twisting.

24. The scaffolding ladder of claim 23, wherein the braces are welded to the side rails of the ladder.

25. The scaffolding ladder of claim 23, wherein the braces are welded to the upper plate of the frames.

26. The scaffolding ladder of claim 23, wherein each of the downwardly depending end plates of the frame has attached flanges and the bottom plate has holes located at opposite ends of the bottom plate.

27. The scaffolding ladder of claim 26 wherein a downwardly depending bolt is secured between each of the flanges attached to the downwardly depending end plates and said bolt is attached with a nut to the bottom plate through the holes in the bottom plate.
